(19) United States
(12) Patent Application Publication
(10) Pub. No.: US 2026/0328903 A1
(43) Pub. Date: Oct. 22, 2026

(54) User Distinction for Radar-Based Gesture Detectors

(71) Applicant: Google LLC, Mountain View, CA (US)

(72) Inventors: Hideaki Matsui, San Francisco, CA (US); Will R. Walker, Oakland, CA (US); Eiji Hayashi, Sunnyvale, CA (US); Jaime Lien, Mountain View, CA (US); Leonardo Giusti, San Francisco, CA (US); Ivan Poupyrev, Los Altos, CA (US)

(73) Assignee: Google LLC, Mountain View, CA (US)

(21) Appl. No.: 19/113,189

(22) PCT Filed: Sep. 30, 2022
(86) PCT No.: PCT/US2022/077388

§ 371 Date: Mar. 19, 2025

(51) Int. Cl. G01S 7/41; G01S 13/88; G06F 3/01; G10L 17/04

(52) U.S. Cl. CPC G01S 7/415; G01S 13/88; G06F 3/017; G10L 17/04; G01S 7/417

(57) ABSTRACT

Techniques and devices for user distinction for radar-based gesture detectors are described in this document. These techniques enable a computing device to distinguish users using a radar system that may collect and analyze radar characteristics of a user to distinguish that user from other users. The radar characteristics may include radar-reflection features of the user such as topological, temporal, gestural, and/or contextual information. A user may be distinguished without determining personally identifiable information, and the computing device may record radar characteristics to distinguish each user at a later time and provide tailored experiences. When an unregistered person is detected, the radar system may assign the unregistered person an unregistered user identification that contains detected radar characteristics to distinguish this person from other users at a future time.

### BACKGROUND

Computing devices that utilize virtual assistant (VA) technology continue to grow in popularity, such as with the advent of VA technology into smart-home systems. Many current VA-equipped devices include an artificial intelligence (AI) assistant, which detects a command made by a user and then instructs a device to perform a task associated with that command. For example, a device may detect a verbal command (e.g., using a microphone) to “turn on the bedroom lights” and send control signals to turn on the lights.

Many VA-equipped devices (e.g., integrated into smart-home systems) have more than one user, and each of these users may want to set their own preferences on the device, protect their information from other users, and perform commands in their own way. This means VA-equipped devices may need to distinguish users, in addition to distinguishing commands, to provide a personalized experience. Some devices, however, are unable to distinguish users, thereby reducing the functionality of VA-equipped devices.

### SUMMARY

This document describes techniques and devices for user distinction for radar-based gesture detectors. These techniques enable a computing device to distinguish users using a radar system that may collect and analyze radar characteristics of a user to distinguish that user from other users. The radar characteristics may include radar-reflection features of the user such as topological, temporal, gestural, and/or contextual information. A user may be distinguished without determining personally identifiable information that includes, for instance, a legal name, biometric information, a personal address, facial details, images, speech-to-text analysis, and so forth. The computing device may record these radar characteristics to distinguish each user at a later time and provide tailored experiences. When a new user (e.g., an unregistered person) is detected, the radar system may assign the unregistered person an unregistered user identification that contains detected radar characteristics to distinguish this person from other users.

Aspects described below include a method, system, apparatus, and means of user distinction for radar-based gesture detectors. The method may include transmitting a radar-transmit signal from a radar system associated with a computing device and receiving a radar-receive signal at the radar system or another radar system associated with the computing device. The computing device may determine, from the radar-receive signal, a radar characteristic of an object from which the radar-receive signal is reflected. Based on the radar characteristic of the object, the computing device may also determine that the object is an unregistered person who is not a registered user associated with the computing device. An unregistered user identification may be assigned to the unregistered person, which may be associated with the radar characteristic of the object. The unregistered user identification and associated radar characteristic may be stored to enable determination, at a future time, of a presence of the unregistered person. The presence may be determined by correlating a future-received radar receive signal, having a similar or identical radar characteristic, with the associated radar characteristic of the unregistered person.

### BRIEF DESCRIPTION OF DRAWINGS

Apparatuses and techniques of user distinction for radar-based gesture detectors are described with reference to the following diagrams.

The same numbers are used throughout the drawings to reference like features and components:

FIG. 1 illustrates an example sequence in which the techniques may be used;

FIG. 2 illustrates an example implementation of the radar system as part of the computing device;

FIG. 3 illustrates an example environment in which multiple computing devices are connected through a communication network to form a computing system;

FIG. 4 illustrates an example environment in which a radar system is used by a computing device to detect the presence of a user;

FIG. 5 illustrates an example implementation of the antenna, the analog circuit, and the system processor of the radar system;

FIG. 6 illustrates example implementations in which the user-detection module may distinguish users;

FIG. 7 illustrates an example implementation of a machine-learned (ML) model used to distinguish users of a computing device;

FIG. 8 illustrates an example implementation of a computing device that uses an additional sensor to improve fidelity of user distinction;

FIG. 9 illustrates an example sequence in which privacy settings are modified based on user presence; and

FIGS. 10-1, 10-2, and 10-3 illustrate an example method of user distinction for radar-based gesture detectors.

### DETAILED DESCRIPTION

### Overview

Computing devices that utilize virtual assistant (VA) technology continue to grow in popularity, such as with the advent of VA technology into smart-home systems. VA-equipped devices may enable users to more easily control, for instance, lights in a room, music being played, calendar reminders, or phone conversations. In particular, these devices may detect a command made by a user that instructs the device to perform a task. Commands may be detected using a microphone or camera and then abstracted (e.g., interpreted for a user's intent) using speech recognition techniques or by identifying visual cues, respectively. For example, a user may provide a voice command of “turn the bedroom lights off,” and the device may interpret the speech (e.g., using speech-to-text techniques) to determine that the bedroom lights should be turned off.

Many VA-equipped devices (e.g., integrated into smart-home systems) have more than one user, and each of these users may want to set their own preferences on the device, protect their information from other users, and perform commands in their own way. Thus, users desire a tailored experience to help expedite tasks, enable better prediction of each user's needs, and improve a user's sense of security around the device. For example, a user may want to provide a command of “check my calendar today” without having to identify themselves every time they are near the device.

Some VA-equipped devices automatically detect and identify users but use sensors and/or recognition techniques that are intrusive. Users may become concerned about the privacy of their personally identifiable information around these devices. For example, a camera may collect images or videos that a user considers private, thereby preventing the user from feeling comfortable near the device. Some devices perform facial recognition techniques that may be used to identify and track users, reducing a user's ability to relax in their home when a VA-equipped device is nearby. For VA-equipped devices that utilize microphones, a user may wonder if the device is listening to their private conversations and performing speech-to-text of conversations other than speech intended to be a command.

Relatedly, a user may desire controls to adaptively change the privacy of their personal information based on the detection of individuals in a room. For example, when a user is alone in a room, they might want to receive audio reminders regarding calendar events (e.g., medical appointments). When the user is with a guest in that room, they may want the device, instead, to refrain automatically from announcing reminders to keep their calendar information private. Many devices, however, do not provide users with adaptive privacy controls, which can reduce the privacy of a user's personal information and/or limit the functionality of the device.

To address these challenges, this disclosure describes a method of user distinction for radar-based gesture detectors. The radar-based gesture detector may primarily utilize a radar system to detect gesture commands performed by a user. The techniques described herein improve performance of VA-equipped devices by utilizing this radar-based gesture detector to: (1) detect and distinguish users without requiring use of personally identifiable information, which enables a tailored experience, (2) prompt users to begin or continue gesture training based on their respective training histories, and (3) adaptively adjust privacy controls to meet a user's expectation of privacy. In this way, a user may enjoy the functionality of the radar-based gesture detector in their home.

### Example Environment

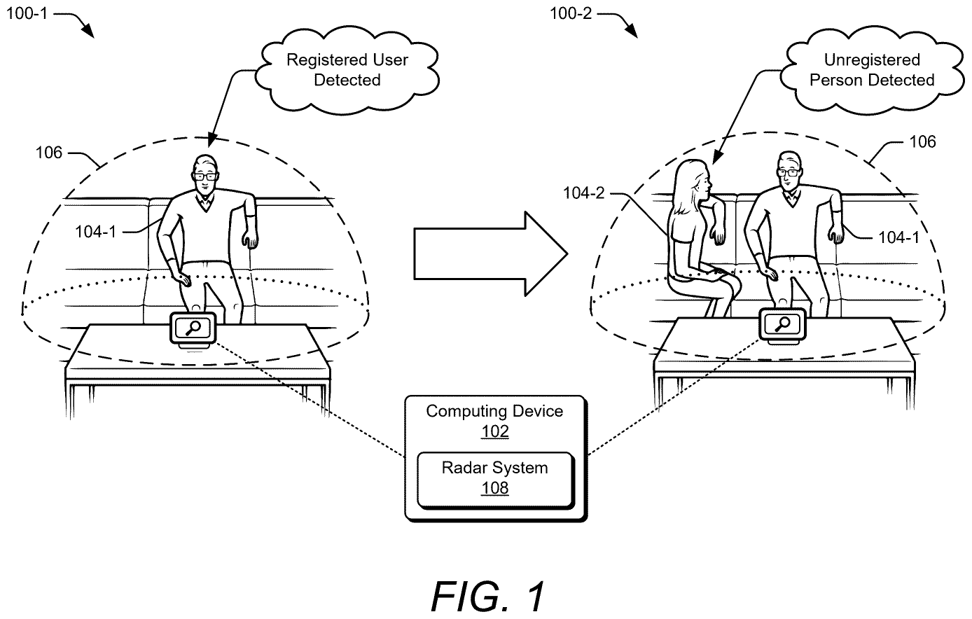

FIG. 1 illustrates an example sequence 100 in which the techniques may be used. These techniques may be performed by a computing device 102 that is configured as a radar-based gesture detector (e.g., a VA-equipped device). The computing device 102 may be used to automize tasks (e.g., operate room lights, control music being played in a room, remind the user of appointments) through gesture commands. For instance, a swipe of a user's hand may indicate a command to change songs being played, while a push-pull gesture may indicate a command to check the status of a timer in the kitchen. The computing device 102 may allow for multiple users 104, each of whom may enjoy a tailored experience with the computing device 102. Furthermore, a first computing device 102-1 may be connected (e.g., wirelessly) to another computing device 102-X (where X represents an integer value of 2, 3, 4, . . . and so forth) to create an interconnected network of radar-based gesture detectors. This network of detectors may be arranged to detect gesture commands in various rooms of, for instance, a smart home.

In particular, the computing device 102 may: (1) detect the presence of a user 104 within a nearby region 106 without personally identifying the user 104, (2) distinguish the user 104 from other users to enable a tailored experience, and then (3) perform an operation upon receiving a gesture command from the user 104. Additionally, or instead of (3), the computing device 102 may prompt the user 104 to begin or continue gesture training, based on that user's training history. In one example, the computing device 102 detects a registered user by correlating a radar-receive signal of a detected object with one or more stored radar characteristics of the registered user. The computing device 102 may then perform operations upon receiving a command and/or may prompt the user to continue gesture training based on their training history.

The computing device 102 may use a radar system 108 to transmit one or more radar-transmit signals (e.g., modulated electromagnetic (EM) waves within a radio frequency (RF) range) to probe the nearby region 106 for user presence. When an object (e.g., a user 104) is detected within the nearby region 106, a radar-transmit signal may reflect off the user 104 and become modified (e.g., in amplitude, time, phase, or frequency) based on the topography and motion of the user 104. This modified radar-transmit signal (e.g., a radar-receive signal) may be received by the radar system 108 and contain information used to distinguish the user 104 from other users. For example, the radar system 108 may use the radar-receive signal to determine a velocity, size, shape, surface smoothness, or material of the user 104. The radar system 108 may also determine a distance between the user 104 and the computing device 102 and/or an orientation of the user 104 relative to the computing device 102.

While the nearby region 106 of example sequence 100 is depicted as a hemisphere, in general, the nearby region 106 is not limited to the topography shown. The topography of the nearby region 106 may also be influenced by nearby obstacles (e.g., walls, large objects). Furthermore, the radar system 108 may probe for and detect users outside of the nearby region 106 depicted in example sequence 100. The boundary of the nearby region 106 may also correspond to an accuracy threshold in which users detected within this boundary are more likely to be accurately distinguished than users detected outside this boundary.

In example sequence 100-1, the computing device 102 sends a first radar-transmit signal into the nearby region 106 and then receives a first radar-receive signal (e.g., a reflected radar-transmit signal) associated with the presence of an object (e.g., a first user 104-1). This first radar-receive signal may include one or more radar characteristics (e.g., radar cross-section (RCS) data, motion signatures, gesture performances, and so forth) that may be used to distinguish the first user 104-1 from other users 104. In particular, the radar system 108 may compare the first radar-receive signal to stored radar characteristics to determine whether the first user 104-1 is a registered user. In this example, the first radar-receive signal is correlated with one or more stored radar characteristics of a registered user.

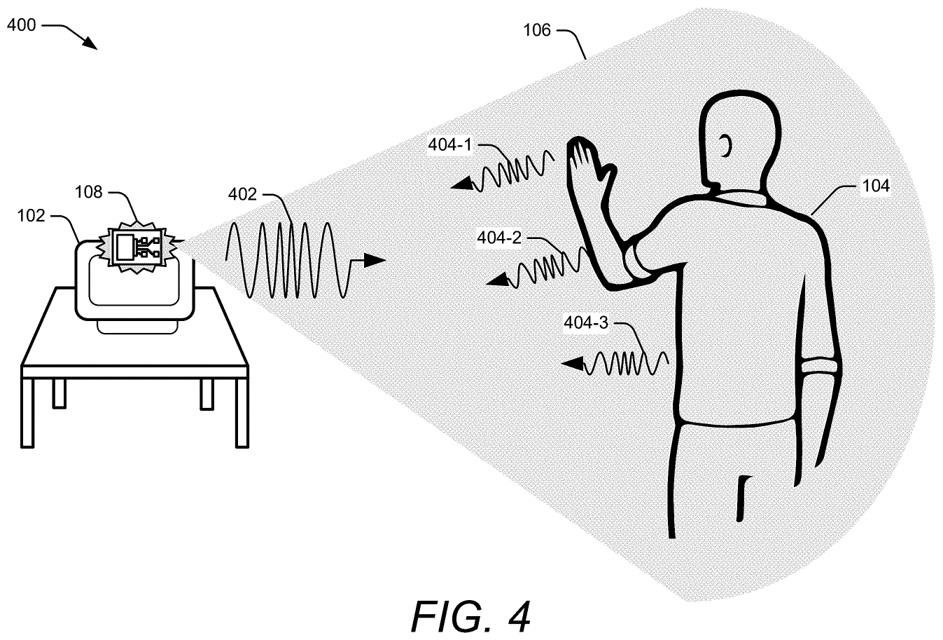

To improve upon some VA-equipped devices, the computing device 102 in example sequence 100-1 may forgo “personally identifying” (e.g., identify private or personally identifiable information of) the first user 104-1 in determining that the detected object is the registered user. For example, the computing device 102 may determine that the first user 104-1 is the registered user without requiring personally identifiable information, which may include legally-identifiable information (e.g., a legal name), a personal address, biometric information, financial information, a browsing history, and so forth. Furthermore, the computing device 102 may forgo identifying a personal device of the first user 104-1 (e.g., a mobile phone, a device equipped with an electronic tag), collect facial-recognition information, or perform speech-to-text of potentially private conversations in determining that the first user 104-1 is the registered user. Instead of personally identifying the first user 104-1, the computing device 102 may “distinguish” the first user 104-1 from another user (e.g., a second user 104-2) using radar characteristics that do not contain confidential information as described with respect to FIG. 4.

A user 104 may be provided with controls allowing the user 104 to make an election as to both if and when the techniques described herein may enable collection of user information (e.g., information about a user's social network, social actions, social activities, profession, photographs taken by the user, audio recordings made by the user, a user's preferences, a user's current location, and so forth), and if the user 104 is sent content or communications from a server. In addition, certain data may be treated in one or more ways before it is stored or used, so that personally identifiable information is removed. For example, a user's identity may be treated so that no personally identifiable information can be determined for the user 104, or a user's geographic location may be generalized where location information is obtained (for example, to a city, ZIP code, or state level), so that a particular location of a user 104 cannot be determined. Thus, the user 104 may have control over what information is collected about the user 104, how that information is used, and what information is provided to the user 104.

After determining that the first user 104-1 is the registered user, the computing device 102 may prompt the first user 104-1 to start or continue gesture training. For example, the first user 104-1 may be partway through training, having already completed training on a first gesture. The computing device 102 may have stored information regarding a way in which the first user 104-1 performed the first gesture during training in a first training history. Based on this first training history (at example sequence 100-1), the computing device 102 may prompt the first user 104-1 to continue training on a second gesture instead of repeating training on the first gesture. As a result, determining that the first user 104-1 is the registered user may allow the computing device 102 to improve the efficiency of gesture training. The distinction of the first user 104-1 may also allow the computing device 102 to activate settings (e.g., privacy settings, preferences) of the registered user to provide a tailored experience for the first user 104-1.

At a later time, shown with example sequence 100-2, a second user 104-2 joins the first user 104-1 on the couch, within the nearby region 106. The computing device 102 may use the radar system 108 to send a second radar-transmit signal to detect the presence of another object (e.g., the second user 104-2). The radar system 108 may then compare the second radar-receive signal to stored radar characteristics to determine whether the second user 104-2 is a registered user. In this example, the second radar-receive signal is not found to correlate to one or more stored radar characteristics of a registered user (either the first user 104-1 or some other registered user). Therefore, the second user 104-2 is distinguished as an unregistered person.

In this disclosure, a registered user is a person with which at least one stored radar characteristic is associated and who, by virtue of a previous registration, has greater rights than a person without a previous registration to the computing device 102 or a device, system, or application associated with the computing device 102 (e.g., to use and access devices and applications). A previous registration can be based on i) a prior-received intention to be registered with the computing device 102 or a device, system, or application associated with the computing device 102 or ii) a previous authorization for recurring use of the computing device 102, or a device, system, or application associated with the computing device 102. In some cases, the one or more stored radar characteristics of the registered user or unregistered person are stored locally and in other cases remotely, as a person may desire that their radar characteristic be stored only locally to address privacy concerns, for example. For example, a prior visitor (e.g., a guest who has previously been detected by the computing device 102 in a home) can have a stored radar characteristic but not have rights associated with a registered person. In another example, a new visitor (e.g., who encounters the computing device 102 for a first time) may have no stored radar characteristic and no rights associated with a registered person.

After determining that the second user 104-2 is an unregistered person, the computing device 102 assigns an unregistered user identification (e.g., mock identity, pseudo identity) to this unregistered person, which may be associated with one or more radar characteristics of the second radar-receive signal. The unregistered user identification may be stored to enable distinction of the second user 104-2 at a future time. In particular, the unregistered user identification may be used to correlate a future-received radar-receive signal with one or more associated radar characteristics of the unregistered person.

Similar to the techniques performed in example sequence 100-1, the computing device 102 may forgo requiring personally identifiable information of the second user 104-2 to determine that the other object is the unregistered person. After the second user 104-2 and the first user 104-1 have been distinguished in example sequence 100-2, the computing device 102 may determine that the privacy settings of the first user 104-1 need to be adapted (e.g., modified, restricted) to ensure the first user's information remains private. For instance, the first user 104-1 may want the device to refrain from announcing calendar reminders (e.g., doctor appointments) while the second user 104-2 is present. Additionally, the computing device 102 may prompt the second user 104-2 to begin gesture training, which may be recorded in a second training history (e.g., associated with the unregistered user identification) of the second user 104-2. While noted in the context of the second user 104-2, personally identifiable information of the first user 104-1 is not necessarily needed by the techniques. Thus, when a person with a stored radar characteristic registers, and therefore becomes a registered user, this registration may forgo personally identifiable information, such as the person's name. In such a case rights to the computing device 102, or a device, system, or application associated with the computing device 102 can be gained through registration. In many cases, however, these rights will be less than those potentially given to a registered user that has provided personally identifiable information, such as a right to access a financial application.

Consider, for example, a situation where a registered user has not provided personally identifiable information, such as the person's name or other unique identifier (e.g., a social security number in the United States). This registered user may still have greater rights than an unregistered user. One such case is where a person, as part of registering with the computing device 102, provides a password or other code that is associated with the computing device 102 rather than the person. The computing device 102, for example, may include a code or other indicator that is available to the purchaser of the computing device 102, such as within the box that the computing device 102 was in when purchased. In essence, the computing device 102 may have a code or information usable by a person to show that that person has additional rights to that of a stranger. While this may not be sufficient to permit access to highly sensitive or person-specific applications and accounts, like a financial account, it may permit access to control devices and applications associated with a home or automobile in which the computing device 102 is placed or associated. Thus, on submitting a password that is sold with the computing device 102 or another device, such as an oven or stereo's serial number, on submitting one of these identifiers, rights associated with that device can be granted to the registered user.

By way of further example, assume that a person buys a VA-equipped device to manage their home. This VA-equipped device includes a password. On or commensurate with the VA-equipped device gaining a radar characteristic of the person, the person submits the password. This then allows the now-registered user to control the home through the VA-equipped device, such as the stereo, oven, door locks, thermostat, and home security system. In this example, these rights are enabled without the person's name or other unique identifier. In so doing, a person may maintain their privacy and yet have rights to control devices and applications through their VA-equipped device (e.g., the computing device 102).

Returning to the prior example, assume that at a later time (not depicted in FIG. 1), the computing device 102 uses the radar system 108 again to send a third radar-transmit signal to detect whether a user 104 is within the nearby region 106. If a user 104 (e.g., the first user 104-1, the second user 104-2) is present at this time, then the third radar-transmit signal may reflect off the user 104 and the computing device 102 may receive a third radar-receive signal, which includes radar characteristics. The radar system 108 may compare these radar characteristics with, for instance, the stored radar characteristics of the first user 104-1 (the registered user) and the second user 104-2 (the unregistered person associated with the unregistered user identification) to determine whether the first user 104-1 or the second user 104-2 is present. Based on this determination, the computing device 102 may tailor settings and training prompts accordingly, such as those differing based on the first user 104-1 being registered (e.g., with an account for the computing device 102) and the second user 104-2 not being registered (e.g., being a guest or friend of the registered user).

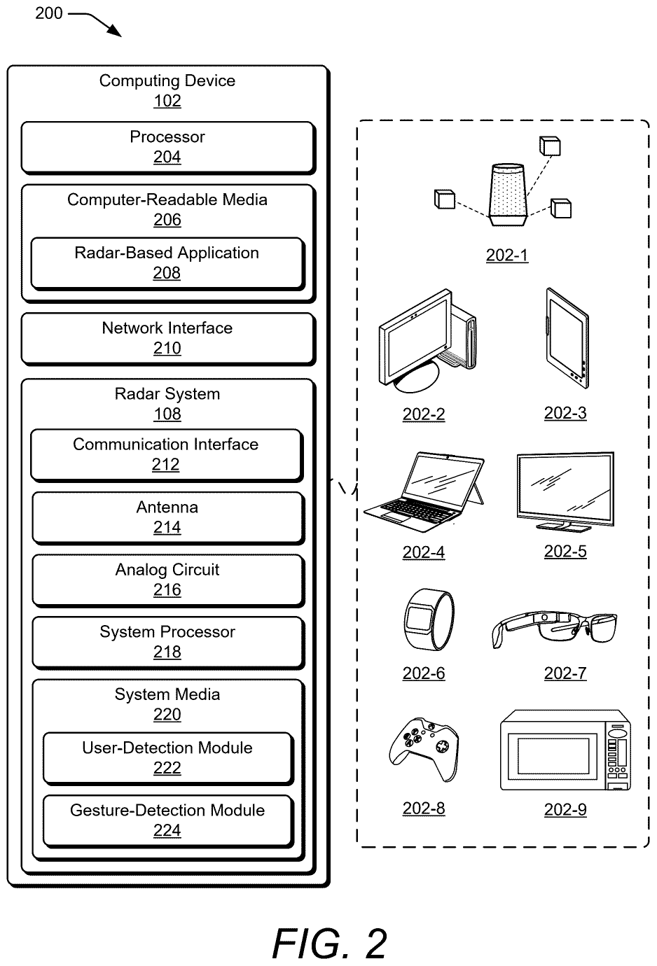

In an example, the radar system 108 uses the third radar-receive signal to determine that the first user 104-1 (the registered user) is present again within the nearby region 106, based on their stored radar characteristics. The computing device 102 may then prompt the first user 104-1 to finish their gesture training based on the first training history and/or activate their user settings. Alternatively, if the radar system 108 determines that the second user 104-2 (the unregistered person) is present again within the nearby region 106, then the computing device 102 may prompt the second user 104-2 to continue their gesture training based on the second training history and/or activate predetermined user settings. The computing device 102 and radar system 108 are further described with reference to FIG. 2.

### Example Computing Device

FIG. 2 illustrates an example implementation 200 of the radar system 108 as part of the computing device 102. The computing device 102 is illustrated with various non-limiting example devices 202 including a home-automation and control system 202-1, a desktop computer 202-2, a tablet 202-3, a laptop 202-4, a television 202-5, a computing watch 202-6, computing glasses 202-7, a gaming system 202-8, and a microwave 202-9. Other devices may also be used, including a home-service device, a smart speaker, a smart thermostat, a security camera, a baby monitor, a Wi-Fi® router, a drone, a trackpad, a drawing pad, a netbook, an e-reader, a home-automation and control system, a wall display, a virtual-reality headset, a vehicle, and another home appliance. Note that the computing device 102 may be wearable, non-wearable but mobile, or relatively immobile (e.g., desktops and appliances).

The computing device 102 may include one or more processors 204 and one or more computer-readable medium (CRM) 206, which may include memory media and storage media. Applications and/or an operating system (not shown) embodied as computer-readable instructions on the CRM 206 may be executed by the processor 204 to provide some of the functionalities described herein. The CRM 206 may also include a radar-based application 208, which uses data generated by the radar system 108 to perform functions, such as gesture-based control. For example, the radar system 108 may detect a gesture performed by a user 104, which indicates a command to turn off the lights in a room. This command data may be used by the radar-based application 208 to send control signals (e.g., triggers) to turn off the lights in the room.

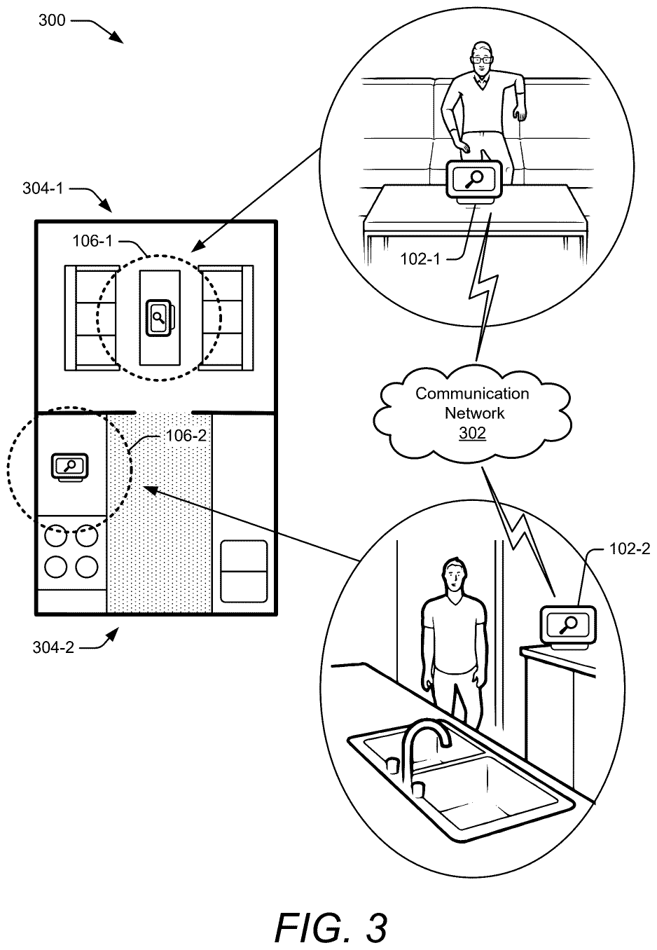

The computing device 102 may also include a network interface 210 for communicating data over wired, wireless, or optical networks. For an interconnected system of multiple computing devices 102-X, each computing device 102 may communicate with another computing device 102 through the network interface 210. For example, the network interface 210 may communicate data over a local-area-network (LAN), a wireless local-area-network (WLAN), a personal-area-network (PAN), a wire-area-network (WAN), an intranet, the Internet, a peer-to-peer network, point-to-point network, a mesh network, and the like. Multiple computing devices 102-X may communicate with each other using a communication network as described with respect to FIG. 3. The computing device 102 may also include a display (not shown).

The radar system 108 may be used as a stand-alone radar system or used with, or embedded within, many different computing devices or peripherals, such as in control panels that control home appliances and systems, in automobiles to control internal functions (e.g., volume, cruise control, or even driving of the car), or as an attachment to a laptop computer to control computing applications on the laptop.

The radar system 108 may include a communication interface 212 to transmit radar data (e.g., radar characteristics) to a remote device, though this may not be used when the radar system 108 is integrated within the computing device 102. In general, the radar data provided by the communication interface 212 may be in a format usable by the radar-based application 208.

The radar system 108 may also include at least one antenna 214 used to transmit and/or receive radar signals. In some cases, the radar system 108 may include multiple antennas 214 implemented as antenna elements of an antenna array. The antenna array may include at least one transmitting antenna element and at least one receiving antenna element. In some situations, the antenna array may include multiple transmitting antenna elements to implement a multiple-input multiple-output (MIMO) radar capable of transmitting multiple distinct waveforms at a given time (e.g., a different waveform per transmitting antenna element). The receiving antenna elements may be positioned in a one-dimensional shape (e.g., a line) or a two-dimensional shape (e.g., a triangle, a rectangle, or an L-shape) for implementations that include three or more receiving antenna elements. The one-dimensional shape may enable the radar system 108 to measure one angular dimension (e.g., an azimuth or an elevation) while the two-dimensional shape may enable two angular dimensions to be measured (e.g., both azimuth and elevation). Each antenna 214 may alternatively be configured as a transducer or transceiver. Furthermore, any one or more antennas 214 may be circularly polarized, horizontally polarized, or vertically polarized.

Using the antenna array, the radar system 108 may form beams that are steered or un-steered, wide or narrow, or shaped (e.g., as a hemisphere, cube, fan, cone, or cylinder). The one or more transmitting antenna elements may have an un-steered omnidirectional radiation pattern or may be able to produce a wide steerable beam. Either of these techniques may enable the radar system 108 to illuminate a large volume of space. To achieve target angular accuracies and angular resolutions, the receiving antenna element may be used to generate thousands of narrow steered beams (e.g., 2000 beams, 4000 beams, or 6000 beams) with digital beamforming. In this way, the radar system 108 may efficiently monitor an external environment and detect gestures from one or more users 104.

The radar system 108 may also include at least one analog circuit 216 that includes circuitry and logic for transmitting and receiving radar signals using the at least one antenna 214. Components of the analog circuit 216 may include amplifiers, mixers, switches, analog-to-digital converters, filters, and so forth for conditioning the radar signals. The analog circuit 216 may also include logic to perform in-phase/quadrature (I/Q) operations, such as modulation or demodulation. A variety of modulations may be used to produce the radar signals, including linear frequency modulations, triangular frequency modulations, stepped frequency modulations, or phase modulations. The analog circuit 216 may be configured to support continuous-wave or pulsed radar operations.

The analog circuit 216 may generate radar signals within a frequency spectrum (e.g., range of frequencies) that includes frequencies between 1 and 400 gigahertz (GHz), between 1 and 24 GHz, between 2 and 6 GHz, between 4 and 100 GHz, or between 57 and 63 GHz. In some cases, the frequency spectrum may be divided into multiple sub-spectrums that have similar or different bandwidths. Example bandwidths may be on the order of 500 megahertz (MHz), one gigahertz (GHz), two gigahertz, and so forth. Different frequency sub-spectrums may include, for example, frequencies between approximately 57 and 59 GHZ, 59 and 61 GHz, or 61 and 63 GHZ. Although the example frequency sub-spectrums described above are contiguous, other frequency sub-spectrums may not be contiguous. To achieve coherence, multiple frequency sub-spectrums (contiguous or not) that have a same bandwidth may be used by the analog circuit 216 to generate multiple radar signals, which are transmitted simultaneously or separated in time. In some situations, multiple contiguous frequency sub-spectrums may be used to transmit a single radar signal, thereby enabling the radar signal to have a wide bandwidth.

The radar system 108 may also include one or more system processors 218 and a system media 220 (e.g., one or more computer-readable storage media). The system processor 218 may be implemented within the analog circuit 216 as a digital signal processor or a low-power processor, for instance. The system processor 218 may execute computer-readable instructions that are stored within the system media 220. Example digital operations performed by the system processor 218 may include Fast-Fourier Transforms (FFTs), filtering, modulations or demodulations, digital signal generation, digital beamforming, and so forth.

The system media 220 may optionally include a user-detection module 222 and a gesture-detection module 224 that may be implemented using hardware, software, firmware, or a combination thereof. The user-detection module 222 and the gesture-detection module 224 may enable the radar system 108 to process radar-receive signals (e.g., electrical signals received at the analog circuit 216) to detect the presence of a user 104 and detect a gesture command, respectively, being performed by a user 104.

The user-detection module 222 and the gesture-detection module 224 may include one or more artificial neural networks (referred to herein as neural networks) to improve user distinction and gesture recognition, respectively. A neural network may include a group of connected nodes (e.g., neurons or perceptrons), which are organized into one or more layers. As an example, the user-detection module 222 and the gesture-detection module 224 may include a deep neural network, which includes an input layer, an output layer, and one or more hidden layers positioned between the input layer and the output layers. The nodes of the deep neural network may be partially connected or fully connected between the layers.

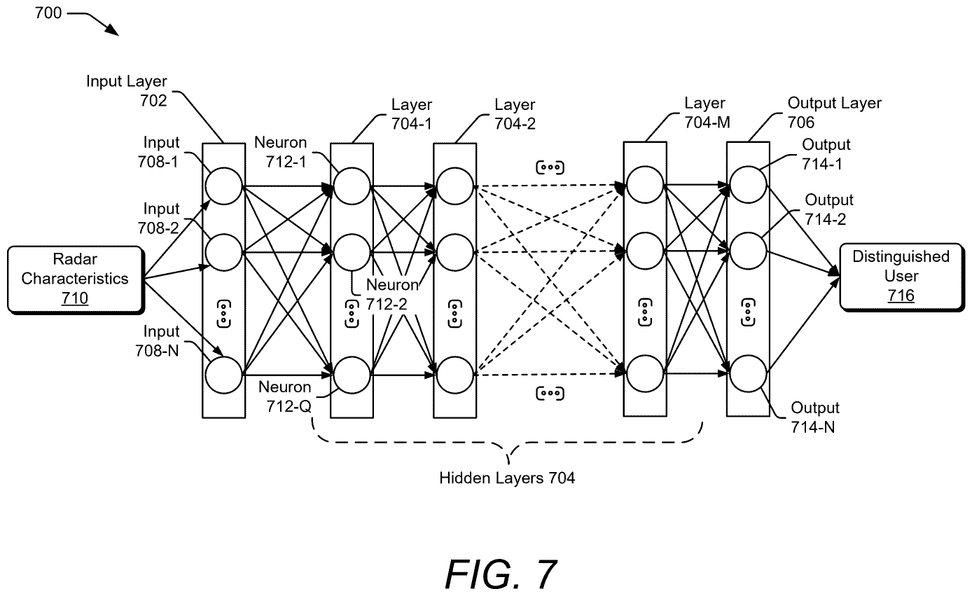

In some cases, the deep neural network may be a recurrent deep neural network (e.g., a long short-term (LSTM) recurrent deep neural network) with connections between nodes forming a cycle to retain information from a previous portion of an input data sequence for a subsequent portion of the input data sequence. In other cases, the deep neural network may be a feed-forward deep neural network in which the connections between the nodes do not form a cycle. Additionally, or alternatively, the user-detection module 222 and the gesture-detection module 224 may include another type of neural network, such as a convolutional neural network. An example deep neural network is further described with respect to FIG. 7. The user-detection module 222 and the gesture-detection module 224 may also include one or more types of regression models, such as a single linear-regression model, multiple linear-regression models, logistic-regression models, stepwise regression models, multi-variate adaptive-regression splines, locally estimated scatterplot-smoothing models, and so forth.

Generally, a machine-learning architecture may be tailored based on available power, available memory, or computational capability. For the user-detection module 222, the machine-learning architecture may also be tailored based on a quantity of radar characteristics that the radar system 108 is designed to recognize. For the gesture-detection module 224, the machine-learning architecture may additionally be tailored based on a quantity of gestures the radar system 108 is designed to recognize.

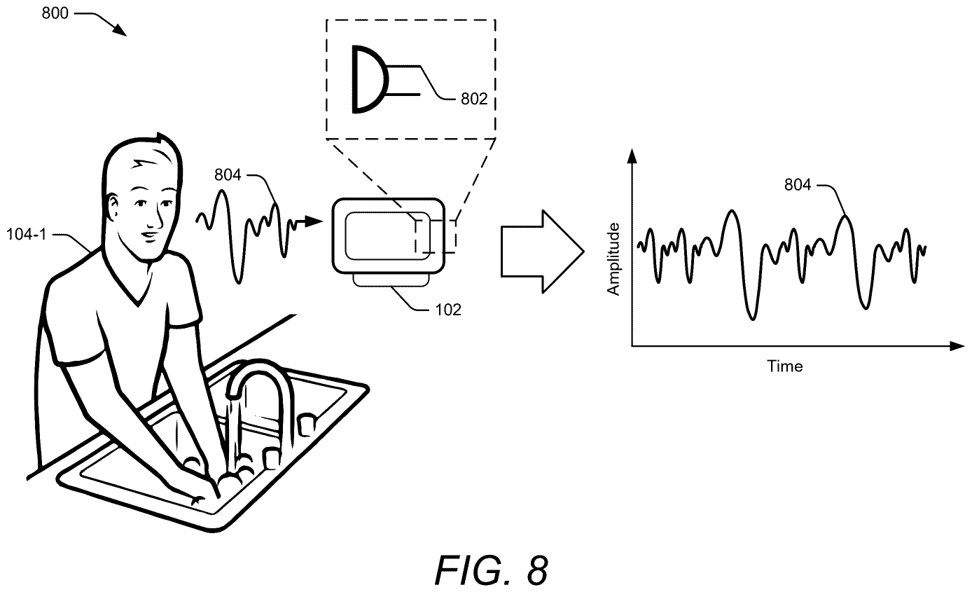

The computing device 102 may optionally (not depicted) include at least one additional sensor (distinct from the antenna 214) to improve fidelity of the user-detection module 222 and/or gesture-detection module 224. In some cases, for example, the user-detection module 222 may distinguish the presence of a user 104 with low certainty (e.g., an amount of certainty that is below a threshold). This may occur, for instance, when the user 104 is far away from the computing device 102 or when there are large objects (e.g., furniture) obscuring the user 104. To increase the accuracy of user distinction, the computing device 102 may verify a low-certainty result using one or more additional sensors as described with respect to FIG. 8. Additional sensors may include, for instance, a microphone, a speaker, an ultrasonic sensor, an ambient light sensor, a camera, a barometer, a thermostat, an optical sensor, and so forth. Similar to the operations performed by the radar system 108, these sensors may forgo detecting, collecting, or enabling storage of a human identification of a user 104 in distinguishing that user from other users of the computing device 102. Multiple computing devices 102-X may also be connected (e.g., wirelessly) to create a computing system as further described with respect to FIG. 3.

### Example Computing System

FIG. 3 illustrates an example environment 300 in which multiple computing devices 102-X are connected through a communication network 302 to form a computing system. Example environment 300 depicts a home with a first room 304-1 (a living room) and a second room 304-2 (a kitchen). The first room 304-1 is equipped with a first computing device 102-1 that includes a first radar system 108-1, and the second room 304-2 is equipped with a second computing device 102-2 that includes a second radar system 108-2. In this example, the first room 304-1 is separate from the second room 304-2 but connected through a door of the home. The first computing device 102-1 in the first room 304-1 may detect users 104 and gestures within a first nearby region 106-1. Whereas the second computing device 102-2 in the second room 304-2 may detect users 104 and gestures within a second nearby region 106-2.

The home of example environment 300 may not be restricted to the arrangement and amount of computing devices 102 shown. In general, an environment (e.g., a home, building, workplace, car, airplane) may include one or more computing devices 102 distributed across one or more rooms 304. For instance, a room 304 may contain two or more computing devices 102 that are positioned near to or far from each other in the room 304. While the first nearby region 106-1 depicted in example environment 300 does not overlap spatially with the second nearby region 106-2, in general, nearby regions 106 may also be positioned to partially overlap. While the environment depicted in FIG. 3 is a home, in general, the environment may include any indoor and/or outdoor space that is private or public such as a library, an office, a workplace, a factory, a garden, a restaurant, a patio, an airplane, a vehicle, and so forth.

For an environment with two or more computing devices 102, the devices may communicate with each other through one or more communication networks 302. A communication network 302 may be a LAN, WAN, mobile or cellular communication network, an extranet, an intranet, the Internet, a Wi-Fi® network, and so forth. In some embodiments, the computing devices 102 may communicate using short-range communication such as, for example, near field communication (NFC), radio frequency identification (RFID), Bluetooth, and so forth. Furthermore, a computing system may include one or more memories that are separate from or integrated into one or more of the constituent computing devices 102-1 or 102-2. In one example, a first computing device 102-1 and a second computing device 102-2 may include a first memory and a second memory, respectively, in which the contents of each memory are shared between devices using the communication network 302. In another example, a memory may be separate from the first computing device 102-1 and second computing device 102-2 (e.g., cloud storage) but accessible to both devices. A memory may be used to, for instance, store radar characteristics of a user 104, user preferences, security settings, training histories, unregistered user identifications, and so forth.

In an example, the first computing device 102-1 may connect to the communication network 302 using a first network interface 210-1 to exchange information with the second computing device 102-2. Using this communication network 302, the computing devices 102 may exchange stored information regarding one or more users 104, which may include radar characteristics, training histories, user settings, and so forth. Furthermore, computing devices 102 may exchange information regarding operations in progress (e.g., timers, music being played) to preserve continuity of operations and/or information regarding operations across various rooms 304. These operations may be performed by one or more computing devices 102 simultaneously or independently based on, for instance, the detection of a user's presence in a room 304. The computing device 102 may use the radar system 108 to detect a user's presence as further described with respect to FIG. 4.

### Radar-Enabled User Detection

FIG. 4 illustrates an example environment 400 in which a radar system 108 is used by a computing device 102 to detect the presence of a user 104. Similar to the discussions regarding example sequence 100, the radar system 108 may transmit one or more radar-transmit signals 402 to probe a nearby region 106 for users 104. For example, the radar system 108 may illuminate a user 104 entering the nearby region 106 with a broad 150° beam of radar pulses (e.g., radar-transmit signals) operating at frequencies of 1-10 kilohertz (kHz). While reference may be made in this disclosure to a radar-transmit signal 402, it is to be understood that the radar system 108 may also transmit a set of radar-transmit signals 402 over a period of time.

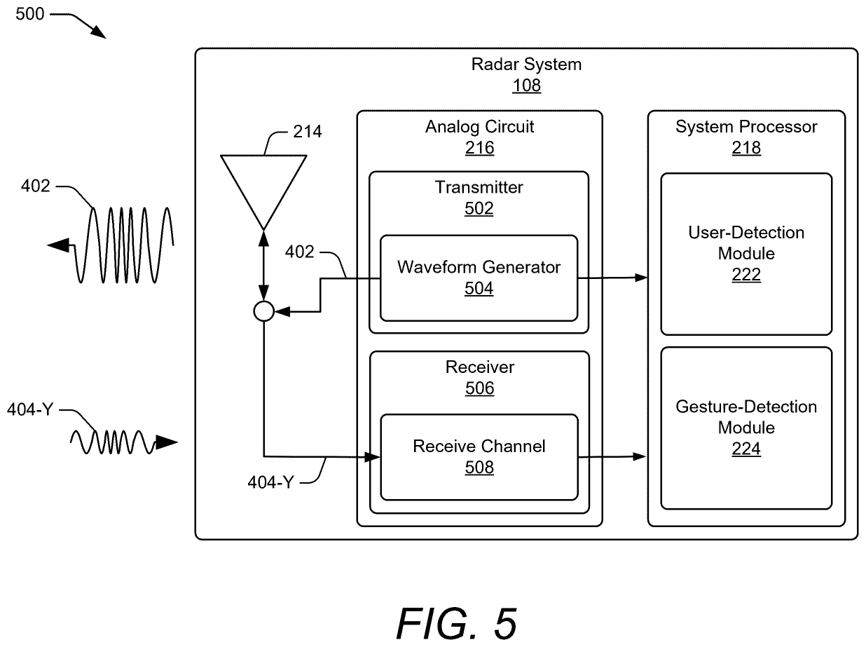

Upon encountering the user 104, a portion of the energy associated with the radar-transmit signal 402 may be reflected back towards the radar system 108 in one or more radar-receive signals 404-Y (where Y may represent an integer value of 1, 2, 3, . . .). In example environment 400, three radar-receive signals 404-1, 404-2, and 404-3 are depicted as being reflected from three discrete dynamic-scattering centers. Each radar-receive signal 404 may represent a modified version of the radar-transmit signal 402 in which an amplitude, time, phase, or frequency is modified at each dynamic-scattering center. A superposition of these radar-receive signals 404 may allow the radar system 108 to distinguish the user 104 using, for instance, a radial distance, geometry (e.g., size, shape, height), orientation, surface texture, material composition, and so forth as further described with respect to FIG. 5.

FIG. 5 illustrates an example implementation 500 of the antenna 214, the analog circuit 216, and the system processor 218 of the radar system 108. In the depicted configuration, the analog circuit 216 may be coupled between the antenna 214 and the system processor 218 to enable the techniques of both user detection and gesture detection. The analog circuit 216 may include a transmitter 502, equipped with a waveform generator 504, and a receiver 506 that includes at least one receive channel 508. The waveform generator 504 and the receive channel 508 may each be coupled between the antenna 214 and the system processor 218.

While one antenna 214 is depicted in example implementation 500, in general, the radar system 108 may include one or more antennas to form an antenna array. When utilizing an antenna array, the waveform generator 504 may generate similar or distinct waveforms for each antenna 214 to transmit into the nearby region 106. Furthermore, while one receive channel 508 is depicted in example implementation 500, in general, the radar system 108 may include one or more receive channels. Each receive channel 508 may be configured to accept a single or multiple radar-receive signals 404-Y at any given time.

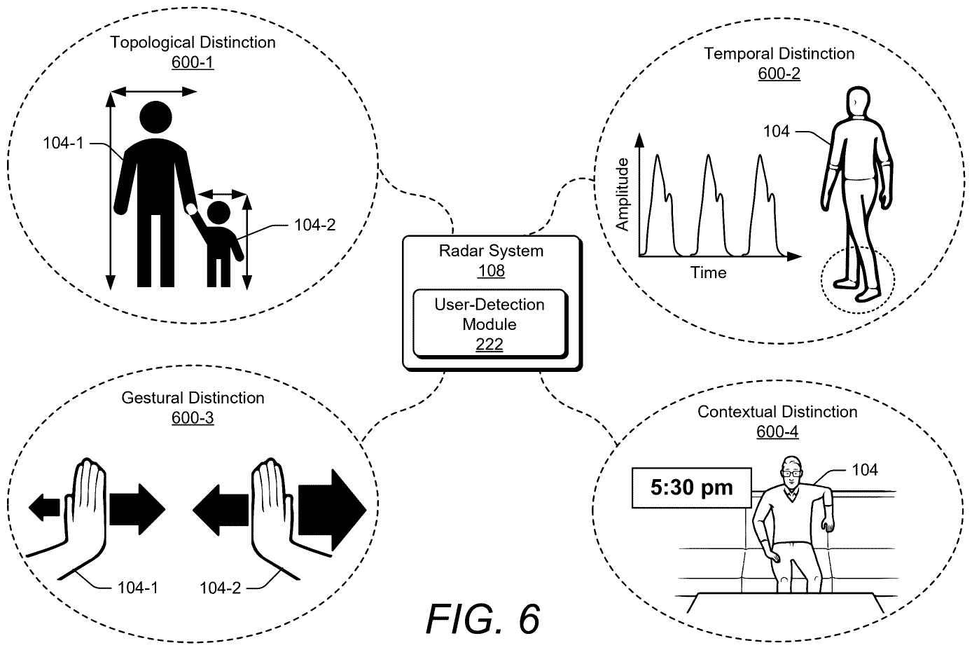

During operation, the transmitter 502 may pass electrical signals to the antenna 214, which may emit one or more radar-transmit signals 402 to probe a nearby region 106 for user presence and/or gesture commands. In particular, the waveform generator 504 may generate the electrical signals with a specified waveform (e.g., specified amplitude, phase, frequency). The waveform generator 504 may additionally communicate information regarding the electrical signals to the system processor 218 for digital signal processing. If the radar-transmit signal 402 interacts with a user 104, then the radar system 108 may receive one or more radar-receive signals 404-Y on the receive channel 508. These radar-receive signals 404-Y may be sent to the system processor 218 to enable user detection (using the user-detection module 222) and/or gesture-detection (using the gesture-detection module 224). The user-detection module 222 may determine whether a user 104 is located within the nearby region 106, and then distinguish the user 104 from other users. A user 104 may be distinguished (but not personally identified) based on one or more radar-receive signals 404-Y as further described with respect to FIG. 6.

### Radar-Enabled User Distinction

FIG. 6 illustrates example implementations 600-1 to 600-4 in which the user-detection module 222 may distinguish users 104. The user-detection module 222 may utilize, in part, one or more radar-receive signals 404 to distinguish, for instance, a first user 104-1 from a second user 104-2 without personally identifying the first user 104-1 or the second user 104-2 (e.g., a legal name, facial recognition information, biometric information, personal address, personal mobile devices, and so forth). By distinguishing users 104, the user-detection module 222 may enable the computing device 102 to provide a tailored experience for each user 104 that recalls, for instance, training histories, preferences, privacy settings, and so forth. In this way, the computing device 102 may improve upon some VA-equipped devices by meeting the privacy and functionality expectations of each user.

To distinguish users 104, the user-detection module 222 may analyze radar-receive signals 404 to determine (1) topological distinctions, (2) temporal distinctions, (3) gestural distinctions, and/or (4) contextual distinctions of a user 104. The user-detection module 222 is not limited to the four categories of distinction depicted in FIG. 6 and may include other radar characteristics and/or categories not shown. Furthermore, the four categories of distinction are shown as example categories and may be combined and/or modified to include subcategories that enable the techniques described herein.

In example implementation 600-1, the user-detection module 222 may use, in part, topological information to distinguish a user 104 upon detecting they are within a nearby region 106. This topological information may include RCS data that includes, for instance, a height, shape, or size of a user 104. For example, a first user 104-1 (e.g., a father) may be significantly larger than a second user 104-2 (e.g., a child). When the father and child enter the nearby region 106, the radar system 108 may obtain radar-receive signals 404 indicating the presence of each user. These radar-receive signals 404 may include, in part, radar characteristics that indicate the height, shape, or size of each user. In this example, the radar characteristics of the father may be distinct from those of the child. The user-detection module 222 may then compare the radar characteristics of each user to stored radar characteristics to determine whether the father and child are registered users, unregistered persons having a stored radar characteristic, or unregistered persons having no stored radar characteristic.

In this example, the user-detection module 222 may determine that the first user 104-1 (the father) is a registered user who previously interacted with the computing device 102. In particular, the user-detection module 222 may correlate stored radar characteristics of the father (e.g., saved to a memory shared by multiple computing devices 102-X) with one or more radar-receive signals 404 to determine that he is a registered user. Upon determining that the first user 104-1 is a registered user, the computing device 102 may activate the father's settings, prompt the father to continue gesture training (based on the father's training history), and so forth.

The user-detection module 222 may also determine that the second user 104-2 (the child) is an unregistered person who has not previously interacted with the computing device 102. In particular, the user-detection module 222 may compare the stored radar characteristics of registered users and unregistered persons to one or more radar-receive signals 404, which contain radar characteristics of the second user 104-2. Upon determining that the radar characteristics of the second user 104-2 do not correlate with any of the stored radar characteristics (e.g., assuming some level of fidelity), the user-detection module 222 may determine that the child is an unregistered person. Instead of personally identifying the child, the radar system 108 may assign the child an unregistered user identification that contains these radar characteristics so that the child may be distinguished from other users (e.g., the father) at a future time. The computing device 102 may also prompt the child to begin gesture training and/or implement predetermined settings (e.g., standard preferences, settings programmed by an owner of the computing device 102).

In general, stored radar characteristics of registered users (and unregistered persons) may be collected and saved. For instance, the radar system 108 may record radar characteristics each time a user 104 interacts with the computing device 102 to improve user recognition. Stored radar characteristics of a user 104 may include topological, temporal, gesture, and/or contextual information inferred from one or more radar-receive signals 404 associated with that user 104. Additionally, the radar system 108 may utilize one or more models used by the user-detection module 222 to distinguish each user 104 based on their corresponding radar characteristics. These one or more models may include a machine-learned (ML) model, predicate logic, hysteresis logic, and so forth to improve user distinction.

In example implementation 600-2, the user-detection module 222 may use, in part, temporal information to distinguish a user 104 upon detecting they are within a nearby region 106. Unlike traditional radar detectors that may require high spatial resolution, the radar system 108 of this disclosure may rely more on temporal resolution (rather than spatial resolution) to detect and distinguish a user 104. In this way, the radar system 108 may detect a user 104 moving into a nearby region 106 by detecting, for instance, a motion signature (e.g., a distinct way in which the user 104 typically moves). A motion signature may include a gait (depicted in the plot of example implementation 600-2), limb motion (e.g., corresponding arm movements), weight distribution, breathing characteristics, unique habits, and so forth. For instance, a user's motion signature may include a limp, an energetic pace, a pigeon-toed walk, knock-knees, bowlegs, and so forth. Using this information, the user-detection module 222 may be able to detect the motion of the user (e.g., a movement of their hand) without identifying details (e.g., facial features enabling facial recognition) that may be considered private. The detection of motion signatures by the radar system 108 may enable users to maintain greater anonymity when compared to, for instance, devices that perform facial recognition or speech-to-text techniques.

In example implementation 600-3, the user-detection module 222 may also use, in part, gesture-performance information to distinguish a user 104. When utilizing radar characteristics associated with gesture performance, the user-detection module 222 may communicate with the gesture-detection module 224. A user may perform a gesture (e.g., a push-pull gesture) in a unique way that may help distinguish that user 104. A push-pull gesture, for instance, may include a push of the user's hand in a direction, followed immediately by a pull of their hand in the opposite direction. While the radar system 108 may expect the push and pull motions to be complementary (e.g., equal in motion extent, equal in speed), the user 104 may perform the motion differently than expected. Each user may perform this gesture in a unique way, which is recorded on the device for user distinction and gesture interpretation.

As depicted in example implementation 600-3, a first user 104-1 (e.g., the father) may perform a push-pull gesture in a different way when compared to a second user 104-2 (e.g., the child). For instance, the first user 104-1 may push their hand to a first extent (e.g., distance) at a first speed but pull their hand back to a second extent at a second speed. The second extent may include a shorter distance than the first extent, and the second speed may be much slower than the first speed. The radar system 108 may be configured to recognize this unique push-pull gesture based on the first user's training history (if available).

When distinguishing the first user 104-1, the radar system 108 may receive one or more radar-receive signals 404 that include radar characteristics of the first user 104-1 associated with their performance of the push-pull gesture. The user-detection module 222 may compare these radar characteristics to stored radar characteristics of registered users to determine whether there is a correlation. If there is a correlation (e.g., assuming some level of fidelity), the user-detection module 222 may determine that the first user 104-1 is a registered user (the father) based on the performance of the push-pull gesture. Similar to the discussions regarding example implementation 600-1, the computing device 102 then may activate settings of the father, prompt the father to continue gesture training, and so forth. In this example, it is assumed that the father performed the push-pull gesture at least once in the past, and the radar characteristics of that performance were recorded in the father's training history to later, in part, enable distinction of the father's presence from the presence of other users.

As also depicted in example implementation 600-3, the second user 104-2 (the child) may try to perform the push-pull gesture as well. The second user 104-2 may push their hand to the first extent at the first speed but pull their hand back to a third extent at a third speed. In this example, the third extent may be much greater than the first extent and the third speed may be much faster than the first speed. In particular, the radar system 108 may receive one or more radar-receive signals 404 that include radar characteristics of the second user 104-2 associated with the performance of this push-pull gesture. The user-detection module 222 may compare these radar characteristics to stored radar characteristics to determine whether there is a correlation. Similar to discussions regarding example implementation 600-1, the user-detection module 222 may determine that the push-pull gesture of the second user 104-2 does not correlate with stored radar characteristics (e.g., training histories) of registered users. Therefore, the user-detection module 222 may determine that the child is an unregistered person and assign the child an unregistered user identification. The radar characteristics associated with the child's push-pull gesture, however, may be included in the unregistered user identification to enable future distinction.

The user-detection module 222 may also use, in part, contextual information to distinguish a user 104. Contextual information may include relevant details (e.g., complementary to radar characteristics) determined by the user-detection module 222 using, for instance, an antenna 214, another sensor of the computing device 102, data stored on a memory (e.g., user habits), local information (e.g., a time, a relative location), and so forth. In example implementation 600-4, the user-detection module 222 may use the local time as context to enable the distinction of a user's presence. If a user 104 (e.g., the father) consistently sits on the living room couch at 5:30 pm every day, the user-detection module 222 may take note of this habit to improve user distinction. Whenever the user 104 is detected on the couch at 5:30 pm, the radar system 108 may, in part, use this contextual information to distinguish this user 104 as the father. In another example, if the computing device 102 is located in a child's room, then the radar system 108 may determine over time that the child is the most-common user in this room. That contextual information may be used to enable user distinction. Similarly, if the computing device 102 is located in a shared space (e.g., a backyard, an entry), the radar system 108 may determine over time that unregistered persons (e.g., guests, nannies, housekeepers, gardeners, friends) are common in this area.

The contextual information gathered by the user-detection module 222 may be used on its own to distinguish a user 104 or in combination with topological information, temporal information, and/or gesture information. In general, the user-detection module 222 may use any one or more of the distinction categories depicted, in any combination, at any time to distinguish a user 104. For instance, the radar system 108 may collect topological and temporal information regarding a user 104 who has entered the nearby region 106 but lack gesture and contextual information. In this case, the user-detection module 222 may distinguish the user 104 based on analysis of the topological information and temporal information. In another case, the radar system 108 may collect topological and temporal information but determine that the information is insufficient to correctly distinguish the user 104 (e.g., to a level of certainty). If contextual information is available, the radar system 108 may utilize that the context to distinguish the user 104 (similar to example implementation 600-4). Any one or more categories depicted in FIG. 6 may be prioritized over another category.

The user-detection module 222 may utilize one or more logic systems (e.g., including predicate logic, hysteresis logic, and so forth) to improve user distinction. Logic systems may be used to prioritize certain user-distinction techniques over others (e.g., favoring temporal distinctions over contextual information), add weight (e.g., confidence) to certain results when relying on two or more categories of distinction, and so forth. For instance, the user-detection module 222 may determine, with low certainty, that a first user 104-1 could be a registered user. A logic system may determine that the low certainty is below an allowed threshold (e.g., limit), and instead prompt the radar system 108 to send out a second radar-transmit signal 402 (or set of signals transmitted over a period of time) to probe the nearby region 106 again. The user-detection module 222 may also include one or more ML models to improve user distinction as further described with respect to FIG. 7.

FIG. 7 illustrates an example implementation 700 of an ML model used to distinguish users 104 of a computing device 102. In the depicted configuration, the ML model is implemented as a deep neural network and may include an input layer 702, multiple hidden layers 704, and an output layer 706. The input layer 702 may include multiple inputs 708-1, 708-2 . . . 708-N, where N represents a positive integer equal to a quantity of radar characteristics 710 associated with one or more radar-receive signals 404. The multiple hidden layers 704 may include layers 704-1, 704-2 . . . 704-M, where M represents a positive integer. Each hidden layer 704 may include multiple neurons, such as neurons 712-1, 712-2 . . . 712-Q, where Q represents a positive integer. Each neuron 712 may be connected to at least one other neuron 712 in a previous hidden layer 704 or a next hidden layer 704. A quantity of neurons 712 may be similar or different between different hidden layers 704. In some cases, a hidden layer 704 may be a replica of a previous layer (e.g., layer 704-2 may be a replica of layer 704-1). The output layer 706 may include outputs 714-1, 714-2 . . . 714-associated with a distinguished user 716 (e.g., a registered user, an unregistered person) that may have been detected within the nearby region 106.

Generally speaking, a variety of different deep neural networks may be implemented with various quantities of inputs 708, hidden layers 704, neurons 712, and outputs 714. A quantity of layers within the ML model may be based on the quantity of radar characteristics and/or distinction categories (as depicted in FIG. 6). As an example, the ML model may include four layers (e.g., one input layer 702, one output layer 706, and two hidden layers 704) to distinguish a first user 104-1 from a second user 104-2 as described with respect to example sequence 100 and example implementations 600. Alternatively, the quantity of hidden layers may be on the order of a hundred.

When utilized by the user-detection module 222, an ML model may improve the fidelity of user distinction. The ML model may collect multiple inputs 708 (e.g., radar characteristics 710 associated with one or more radar-receive signals 404) over time that include topological, temporal, gesture, and/or contextual information regarding a user 104. For example, the second user 104-2 (e.g., the child) may be positioned far from the radar system 108 during a first interaction with the computing device 102, resulting in a first set of inputs 708 used to distinguish the child as an unregistered person. The first set of inputs 708 may be included in the unregistered user identification assigned to the child. On a second interaction, the child may be seated close to the radar system 108, resulting in a second set of inputs 708 used to distinguish the child. This second set of inputs 708 are distinct from the first set and may also be included in the unregistered user identification of the child. This process may continue over time, providing the ML model with more inputs 708 to better distinguish (e.g., with higher accuracy, greater speed) the child at a future time.

The gesture-detection module 224 may also collect gesture performance information of a user 104 during training, as input to the ML model, to enable the user-detection module 222 to distinguish users based on gesture performance. If the first user 104-1 performs the push-pull gesture four times during training, then there may be at least four inputs 708-1, 708-2, 708-3, and 708-4 to the ML model. The user-detection module 222 may utilize, in part, one or more outputs 714 of the ML model to distinguish the first user 104-1 (e.g., the father) when he performs the push-pull gesture at a future time.

In general, the ML model may be integrated into the user-detection module 222, the radar system 108, the computing device 102, or located separate from the computing device 102 (e.g., a shared server). The gesture-detection module 224 may also include a similar ML model that may improve the detection and distinction of gestures being performed by a user 104. For example, the gesture-detection module 224 may detect a push-pull gesture, being performed by a first user 104-1, and then utilize the ML model outputs 714 to interpret the gesture as a command. Operations of the gesture-detection module 224 may be performed at the same time or a separate time from operations performed by the user-detection module 222. The fidelity of user distinction may also be improved using additional sensors (e.g., non-radar sensors) of the computing device 102 as further described with respect to FIG. 8.

### Optional Sensors to Improve Fidelity of User Distinction

FIG. 8 illustrates an example implementation 800 of a computing device 102 that uses an additional sensor (e.g., a microphone 802) to improve fidelity of user distinction. In some situations, the radar characteristics associated with a nearby object (e.g., a registered user or unregistered person) may not provide enough information to distinguish a user 104 to a specific level of certainty. As depicted in example implementation 800, the user-detection module 222 may not be able to determine with certainty that the first user 104-1 is a registered user (e.g., the father) based only on radar and/or other characteristics described above. In this situation, the computing device 102 may bootstrap audio signals 804 (e.g., sound waves made by the first user 104-1) to enable the radar system 108 to determine that the father is present.

As depicted in example implementation 800, the user-detection module 222 may receive audio signals 804 through a microphone 802 and analyze characteristics (e.g., wavelengths, amplitudes, time periods, frequencies, velocities, speeds) of these sound waves to determine which user is present in the nearby region 106. This analysis made be performed when triggered, automatically, concurrently with or after the analysis of radar characteristics, and so forth. Audio signals 804 may be modified by additional circuitry and/or components, before being received by the user-detection module 222.

The user-detection module 222 may analyze the audio signals 804, without accessing private information (e.g., content of conversations), to distinguish users. For instance, the radar system 108 may characterize the audio signals 804, without identifying words being spoken (e.g., performing speech-to-text), to distinguish the presence of the first user 104-1. The radar system 108 may also characterize the audio signals 804 in terms of a pitch, loudness, tone, timbre, cadence, consonance, dissonance, patterns, and so forth. As a result, the user 104 may comfortably discuss private information near the computing device 102 without worrying about whether the device is identifying words, sentences, ideas, and so forth, being spoken.

The computing device 102 may store audio-detected characteristics of one or more users 104 (e.g., on a shared memory) to enable distinction of a user's presence. When a registered user (e.g., the father) enters the nearby region 106 of the radar system 108, then the user-detection module 222 may, in part, utilize stored audio-detected characteristics of the father to distinguish him from other users of the device. When an unregistered person enters the nearby region 106, then the user-detection module 222 may, in part, utilize stored audio-detected characteristics of registered users to determine that this is an unregistered person who, for instance, has not provided audio signals 804 to the computing device 102. The radar system 108 may then generate an unregistered user identification for this unregistered person, which includes audio-detected characteristics associated with one or more audio signals 804 made by the unregistered person. Therefore, the radar system 108 may be able to distinguish this unregistered person at a later time using the audio-detected characteristics stored in their unregistered user identification.

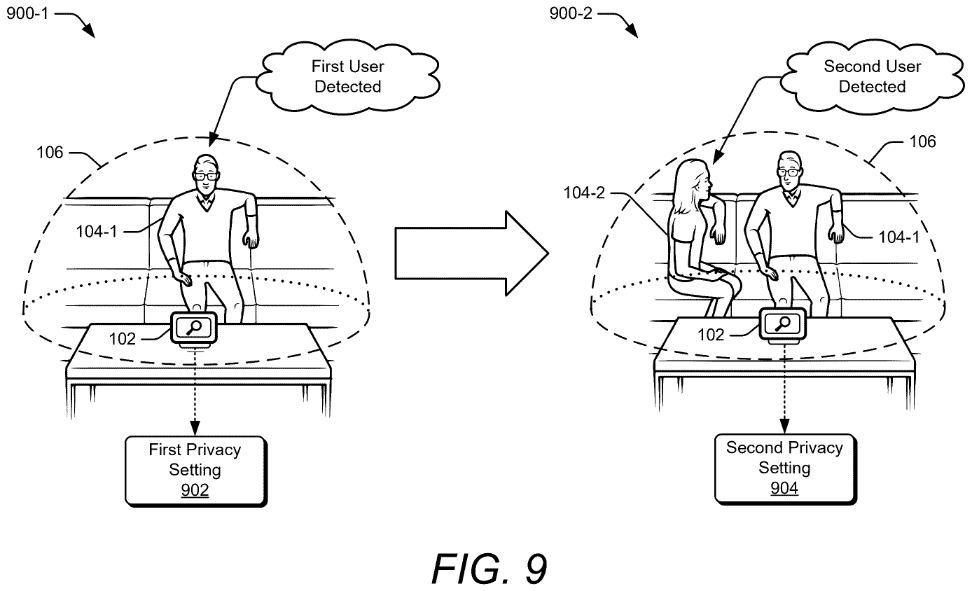

In general, additional sensor input (e.g., audio signals 804 from a microphone 802) is optional, and a user 104 may be afforded privacy controls to limit the use of such additional sensors. For instance, a user 104 may modify their personal settings, general settings, default settings, and so forth to include and/or exclude any additional sensor (e.g., additional to the antenna 214 used for radar). Furthermore, the user-detection module 222 may implement these personal settings upon distinguishing a user's presence. While example implementation 800 described the additional sensor as a microphone 802, in general, the techniques described with respect to FIG. 8 may be applied to, for instance, an ultrasonic sensor, an ambient light sensor, accelerometer, gyroscope, magnetometer, proximity sensor, ambient temperature sensor, light sensor, pressure sensor, touch sensor, and so forth. Privacy controls are further described with respect to FIG. 9.

### Adaptive Privacy

FIG. 9 illustrates an example sequence 900-1 and 900-2 in which privacy settings are modified based on user presence. In example sequence 900-1, the user-detection module 222 of the computing device 102 detects that the first user 104-1 is present within the nearby region 106. In lieu of detecting the presence of one or more other users (e.g., registered users, unregistered persons), the radar system 108 may implement a first privacy setting 902 of the first user 104-1. This first privacy setting 902 may include user preferences regarding, for example, allowed sensors (with reference to FIG. 8), audio reminders, calendar information, music, media, settings of household objects (e.g., light preferences), and so forth. For instance, the first user 104-1 may receive audio reminders of calendar events when the first privacy setting 902 has been implemented.

In example sequence 900-2, the computing device 102 may later detect the presence of a second user 104-2 (e.g., another registered user) in addition to the continued presence of the first user 104-1. The radar system 108 may now implement a second privacy setting 904 to adapt the privacy of the first user 104-1 based on the second user's presence. Implementation may be automatic or triggered based on a command from the first user 104-1. For instance, the second privacy setting 904 may restrict audio reminders to prevent private information from being announced in the presence of others. The second privacy setting 904 may be based on, for example, preset conditions, user inputs, and so forth.

The second privacy setting 904 may also be implemented to protect the privacy of the second user's information and adapted based on users in the room. For example, the presence of another registered user (e.g., a family member) may require fewer privacy restrictions than the presence of an unregistered person (e.g., a guest). Adaptive privacy settings may also be tailored for each user 104. For instance, the first user 104-1 may have more restrictive privacy settings (e.g., restricting audio reminders in the presence of others) while the second user 104-2 may have less-restrictive privacy settings (e.g., not restricting audio reminders in the presence of others).

Adaptive privacy may also be applied to operations in progress. In an example, a first user 104-1 (e.g., a father) may start an oven and set a timer for 20 minutes. If a second user 104-2 (e.g., a child) attempts to turn the oven off before the timer has expired, then the radar system 108 may prevent the child from changing this operation. This may allow the father to control the operations of the oven during those 20 minutes to prevent disruptions to the baking. In particular, the radar system 108 may associate operations in progress with the user 104 who performed the command to prevent another user from modifying their operation. In another example, a mother may perform a command to turn off the bedroom lights at 9:00 pm to ensure their child goes to sleep on time. If a child performs a command to keep the lights on past their bedtime, the radar system 108 may prevent the child from modifying the command of the mother. The techniques of user distinction for radar-based gesture detectors are not limited to the examples illustrated in FIGS. 1-9 and are more generally described with respect to FIGS. 10-1, 10-2, and 10-3.

### Example Method

FIGS. 10-1, 10-2, and 10-3 illustrate an example method 1000 of user distinction for radar-based gesture detectors. Method 1000 is shown as sets of operations (or acts) performed and is not necessarily limited to the order or combinations in which the operations are shown herein. Furthermore, any of one or more of the operations may be repeated, combined, reorganized, or linked to provide a wide array of additional and/or alternative methods. In portions of the following discussion, reference may be made to example environments or example sequences of FIGS. 1-9, reference to which is made for example only. The techniques are not limited to performance by one entity or multiple entities operating on one computing device 102.

At 1002, a radar-transmit signal is transmitted from a radar system of a computing device. For example, a radar-transmit signal 402 may be transmitted from a radar system 108 of a computing device 102 to detect whether a user 104 is present within a nearby region 106, with reference to FIG. 1. The radar-transmit signal 402 may include a single signal, multiple signals that are similar or distinct, a burst of signals, continuous signals, and so forth as described with reference to FIG. 4.

At 1004, a radar-receive signal is received at the computing device. For example, one or more radar-receive signals 404-Y (where Y may represent an integer value of 1, 2, 3, . . . ) may be received by the radar system 108 of the computing device 102.

At 1006, a radar characteristic of an object, from which the radar-receive signal is reflected, is determined by the computing device. For example, one or more radar characteristics of an object (e.g., a user 104), from which the radar-receive signal 404-Y is reflected, is determined by the radar system 108 of the computing device 102. The one or more radar characteristics may be used to distinguish users and include, for instance, topological, temporal, gesture, and/or contextual information as described with respect to FIG. 6. The computing device 102 may forgo determining personally identifiable information of a user 104 detected in a nearby region 106. Simultaneously or at a different time, at 1008, the computing device may (optionally) receive an audio signal associated with the object. For example, the computing device 102 may receive one or more audio signals 804, using a microphone 802, that are associated with the object (e.g., the user 104).

At 1010, the computing device may determine the object is an unregistered person. For example, a user-detection module 222 of the radar system 108 may determine a presence of an unregistered person based on one or more radar characteristics of the radar-receive signal 404-Y. In particular, the radar system 108 may compare a first radar characteristic of a first radar-receive signal 404-1 to one or more stored radar characteristics. The stored radar characteristics may include one or more radar characteristics of a registered user or previously detected unregistered person, which may be saved onto, for instance, a memory. If the first radar characteristic correlates with one or more stored radar characteristics, then the user-detection module 222 may determine that a registered user is present. At 1010, however, the radar system 108 determines that the detected radar characteristics are not correlated with (e.g., not similar or identical to) one or more stored radar characteristics. Therefore, the radar system 108 determines that this lack of correlation indicates a presence of an unregistered person. The presence of the unregistered person may be determined without requiring personally identifiable information as described with respect to FIG. 1. The user-detection module 222 may optionally utilize one or more audio signals 804, received by the computing device 102, to determine the presence of the unregistered person.

At 1012, the unregistered person is assigned an unregistered user identification. For example, the unregistered person may be assigned an unregistered user identification (e.g., mock identity, pseudo identity) by the radar system 108 of the computing device 102.

The computing device may also optionally perform any one or more of the operations identified at 1014, 1016, and 1018 before continuing to block 1020. At 1014, the computing device may provide gesture training. For example, the radar system 108 of the computing device 102 may provide gesture training for the unregistered person as described with reference to FIG. 1. For instance, the radar system 108 may assume that a new user (the unregistered person) has not performed gesture training and may prompt the unregistered person to begin training on one or more gestures. At 1016, the computing device may maintain a first training history. For example, the computing device 102 may store one or more radar characteristics, associated with a way in which the unregistered person performs a gesture during training, to the unregistered user identification of the unregistered person.

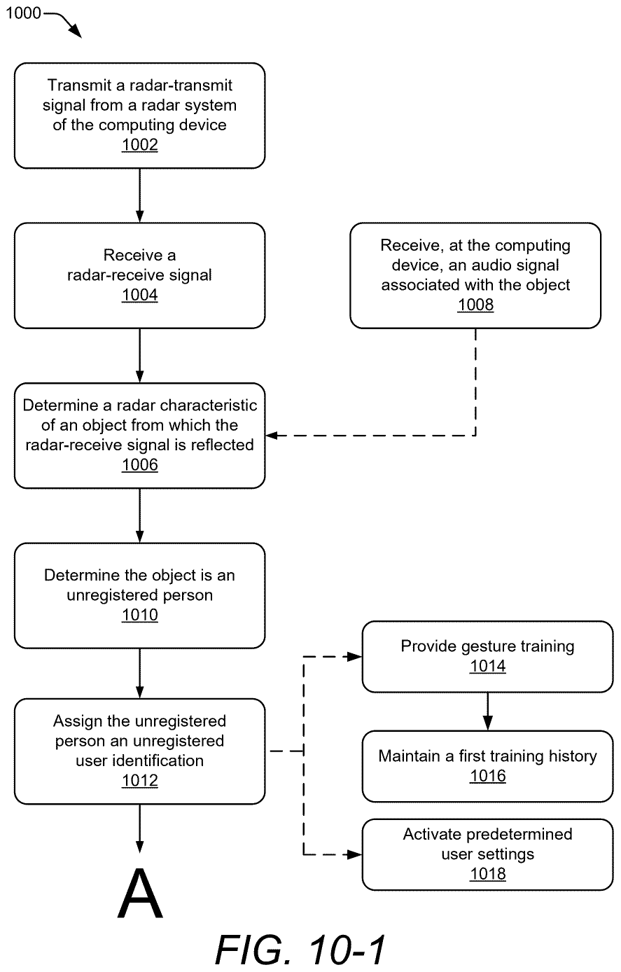

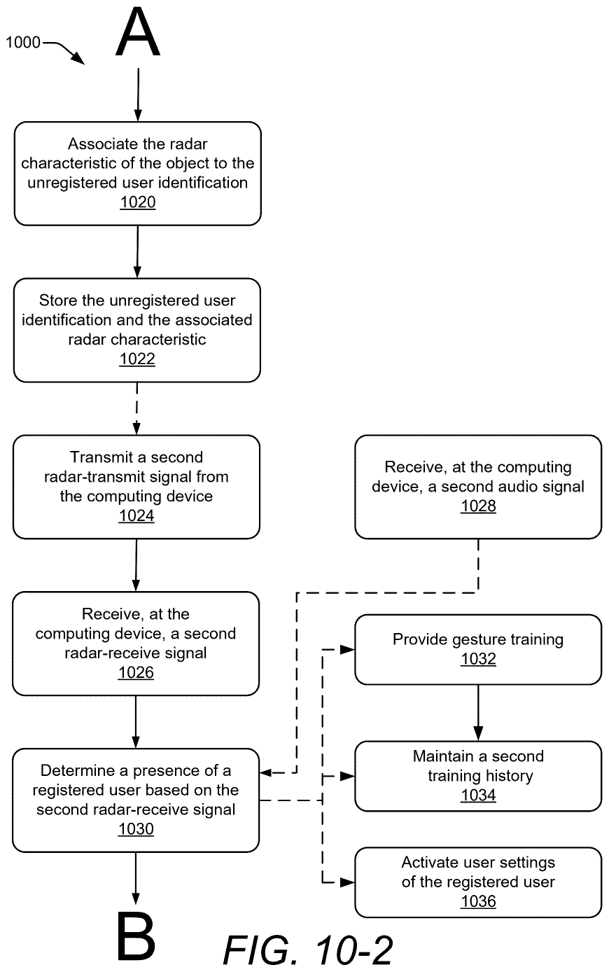

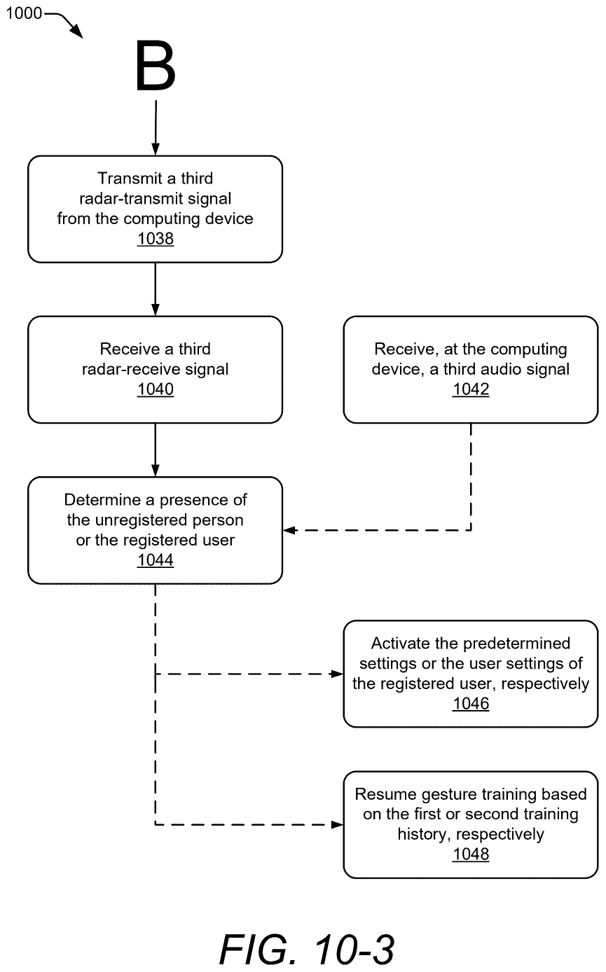

At 1018, the computing device may optionally activate predetermined user settings. For example, the radar system 108 of the computing device 102 may activate predetermined user settings (e.g., default preferences, default privacy settings) with reference to discussions regarding FIG. 9. The description of method 1000 continues in FIG. 10-2, as indicated by the letter “A” after block 1012 of FIG. 10-1, which corresponds to the letter “A” before block 1020 of FIG. 10-2.

At 1020, the radar characteristic of the object is associated with the unregistered user identification. For example, the one or more radar characteristics of the object (e.g., the unregistered person) may be associated with the unregistered user identification. The unregistered user identification may also include settings and a training history for the unregistered person.

At 1022, the unregistered user identification and the associated radar characteristic are stored by the computing device. For example, the radar system 108 of the computing device 102 may store both the unregistered user identification and the one or more radar characteristics associated with the unregistered person on a memory (e.g., local, shared, remote). In this way, the unregistered user identification may be used, in part, to distinguish the unregistered person from other users at a future time.

The computing device 102 may optionally perform any one or more steps after block 1022. These steps may be performed in any order and/or may be repeated. While blocks 1024-1048 are depicted after blocks 1002-1022, they may be performed before or during any one or more blocks of 1002-1022.

At 1024, a second radar-transmit signal is transmitted from the computing device. For example, a second radar-transmit signal 402-2 may be transmitted from the radar system 108 of the computing device 102 to detect whether another user 104 is present within the nearby region 106, with reference to FIGS. 1 and 4.

At 1026, a second radar-receive signal is received at the computing device. For example, a second radar-receive signals 404-2 may be received by the radar system 108 of the computing device 102. Simultaneously or at a different time, at 1028, the computing device may (optionally) receive a second audio signal. For example, the computing device 102 may receive a second audio signal 804-2 using the microphone 802.

At 1030, the computing device may determine a presence of a registered user based on the second radar-receive signal. For example, a user-detection module 222 of the radar system 108 may determine a presence of a registered user based on the second radar-receive signal 404-2. In particular, the radar system 108 may compare a second radar characteristic of the second radar-receive signal 404-2 to one or more stored radar characteristics. If the second radar characteristic correlates with one or more stored radar characteristics, then the user-detection module 222 may determine that a registered user (or unregistered user having a stored radar characteristic) is present. At 1030, the radar system 108 determines that the detected radar characteristics correlate with (e.g., are similar or identical to) one or more stored radar characteristics of a registered user. Therefore, the radar system 108 determines the presence of a registered user. The presence of the registered user may also be determined without requiring personally identifiable information as described with respect to FIG. 1. The user-detection module 222 may optionally utilize the second audio signal 804-2, received by the computing device 102, to determine the presence of the registered user.

Optionally, the computing device may perform any one or more of the operations identified at 1032, 1034, and 1036 before continuing to block 1038. At 1032, the computing device may provide gesture training. For example, the radar system 108 of the computing device 102 may provide gesture training to the registered user as described with reference to FIG. 1. The gesture training may be tailored to the registered user based on their training history. For instance, if the registered user has previously trained on one of four gestures, then the radar system 108 (e.g., using the gesture-detection module 224 or another module of the system media 220) may prompt the registered user to continue training on the remaining three of the four gestures. In this way, the training may be tailored and prevent the registered user from unnecessarily retraining. When the registered user resumes training on the remaining three gestures (e.g., at 1032) the computing device 102 may maintain a second training history for the registered user.

At 1036, the computing device may optionally activate user settings of the registered user upon determining the presence of the registered user. For example, the radar system 108 of the computing device 102 may activate user settings (e.g., preferences, privacy settings) of the registered user with reference to discussions regarding FIG. 9. These operations may also be performed for unregistered persons having a radar characteristic, such as one associated with an unregistered user identification for that unregistered person.

The description of method 1000 continues in FIG. 10-3, as indicated by the letter “B” after block 1030 of FIG. 10-2, which corresponds to the letter “B” before block 1038 of FIG. 10-3.

At 1038, a third radar-transmit signal is transmitted from the computing device. For example, a third radar-transmit signal 402-3 may be transmitted from the radar system 108 of the computing device 102 to detect whether the unregistered person or the registered user is present within the nearby region 106, with reference to FIGS. 1 and 4.

At 1040, a third radar-receive signal is received at the computing device. For example, a third radar-receive signal 404-3 may be received by the radar system 108 of the computing device 102. Simultaneously or at a different time, at 1042, the computing device may (optionally) receive a third audio signal. For example, the computing device 102 may receive a third audio signal 804-3 using the microphone 802.

At 1044, the computing device may determine a presence of the registered user or the unregistered person based on the third radar-receive signal. For example, the user-detection module 222 of the radar system 108 may determine the presence of the registered user or the unregistered person based on one or more radar characteristics of the third radar-receive signal 404-3. In particular, the radar system 108 may compare a third radar characteristic of the third radar-receive signal 404-3 to one or more stored radar characteristics, similar to discussions of 1010 and 1030.

Optionally, the computing device may perform any one or more of the operations identified at 1046 and 1048. At 1046, the computing device may activate the predetermined settings or the user settings of the registered user, respectively. For example, the radar system 108 may activate the predetermined user settings if (at 1044) the device detects the presence of the unregistered person. Similarly, the radar system 108 of the computing device 102 may activate the user settings of the registered user if (at 1044) the device detects the presence of the registered user. At 1048, the computing device may resume gesture training based on the first training history or the second training history, respectively. For example, the radar system 108 may provide gesture training to the unregistered person based on the first training history, associated with the unregistered user identification, if (at 1044) the device detects the presence of the unregistered person. Similarly, the radar system 108 of the computing device 102 may provide gesture training to the registered user based on the second training history if (at 1044) the device detects the presence of the registered user.

### Conclusion

Although techniques and apparatuses of user distinction for radar-based gesture detectors have been described in language specific to features and/or methods, it is to be understood that the subject of the appended claims is not necessarily limited to the specific features or methods described. Rather, the specific features and methods are disclosed as example implementations of user distinction for radar-based gesture detectors.

Some Examples are described below.
Example 1: A method comprising: transmitting a radar-transmit signal from a radar system associated with a computing device; receiving, at the radar system or another radar system associated with the computing device, a radar-receive signal; determining, from the radar-receive signal, a radar characteristic of an object from which the radar-receive signal is reflected; determining, based on the radar characteristic of the object, that the object is an unregistered person, the unregistered person not a registered user associated with the computing device; assigning, to the unregistered person, an unregistered user identification; associating the radar characteristic of the object to the unregistered user identification; and storing the unregistered user identification and the associated radar characteristic, the associated radar characteristic usable to determine, at a future time, a presence of the unregistered person by correlating a future-received radar-receive signal having a similar or identical radar characteristic with the associated radar characteristic of the unregistered person.
Example 2: The method as recited by example 1, the method further comprising: transmitting a second radar-transmit signal from the radar system or the other radar system associated with the computing device; receiving, at the radar system or the other radar system, a second radar-receive signal associated with a second radar characteristic, the second radar characteristic similar or identical to the associated radar characteristic of the unregistered person; and comparing the second radar characteristic to the radar characteristic associated with the stored unregistered user identification, the comparing effective to determine the presence of the unregistered person.
Example 3: The method as recited by any preceding example, the method further comprising: transmitting a third radar-transmit signal from the radar system or the other radar system associated with the computing device; receiving, at the radar system or the other radar system, a third radar-receive signal associated with a third radar characteristic; and comparing the third radar characteristic to one or more stored radar characteristics of registered users, the comparing effective to correlate the third radar characteristic to a first stored radar characteristic of a registered user, the correlation indicating a presence of the registered user.
Example 4: The method as recited by any preceding example, wherein the presence of the unregistered person or a presence of a registered user is determined without using personally identifiable information, the personally identifiable information including at least one of the following: face-recognition information; biometric information; content of private conversations; legally identifiable information; identification of an electronic tag; identification of a personal electronic device; or private information.
Example 5: The method as recited by any preceding example, wherein the radar characteristic includes topological information of the object, the topological information including at least one of the following: radar cross-sectional data; geometric information; texture information; a surface smoothness; or a structural configuration.
Example 6: The method as recited by any preceding example, wherein the radar characteristic includes temporal information of the object, the temporal information associated with one or more movements of the object over time.
Example 7: The method as recited by any preceding example, wherein the radar characteristic includes gestural information associated with a way in which the object performs one or more gestures to control or alter a display, function, or capability of the computing device or associated with the computing device.
Example 8: The method as recited by any preceding example, further comprising associating, with the unregistered user identification, contextual information including at least one of the following: a status of operations being performed by the computing device at a current time, past time, or scheduled time; a location of the computing device; or a recorded habit or preference of the registered user or the unregistered person.
Example 9: The method as recited by example 8, wherein the contextual information includes the recorded habit or preference of the unregistered person, the recorded habit or preference including a time of day or day of a week, and further comprising determining, based on the stored associated radar characteristic and the time of the day or the day of the week, the presence, at the future time, of the unregistered person.
Example 10: The method as recited by any preceding example, the method further comprising: responsive to determining that the object is the unregistered person, providing gesture training to teach the unregistered person to perform a gesture to control or alter a display, function, or capability of the computing device or associated with the computing device; storing, for the unregistered person, a training history for the gesture as performed by the unregistered person during gesture training, the stored training history associated with the unregistered user identification; and responsive to determining the presence of the unregistered person at the future time, either: resuming gesture training based on the stored training history; or recognizing, based on the stored training history, a future-received gesture as the gesture to control or alter the display, function or capability.
Example 11: The method as recited by any preceding example, wherein determining the presence of the unregistered person at the future time is further based on a machine-learned model that utilizes the associated radar characteristic of the unregistered person.
Example 12: The method as recited by any preceding example, the method further comprising: detecting, at the computing device, a first gesture performed by the unregistered person, the first gesture associated with an operation to be performed by the computing device over a duration of time; implementing the operation; detecting, at the computing device, a second gesture performed by another user to change the operation during the duration of time; and refraining from changing the operation based on the second gesture being performed by the other user who is not the unregistered person.
Example 13: The method as recited by any preceding example, the method further comprising: receiving, at the computing device, an audio signal of the object; determining an audio characteristic of the audio signal without determining one or more words associated with the audio signal; and responsive to determining that the object is the unregistered person: associating the audio characteristic with the unregistered user identification; and storing the associated audio characteristic to enable determination of the presence of the unregistered person at the future time by correlating a future-received audio signal having a similar or identical audio characteristic with the associated audio characteristic.
Example 14: The method as recited by any preceding example, wherein the radar system is configured to transmit and receive radar signals within a radio frequency range.
Example 15: A computing device comprising: at least one antenna; a radar system configured to transmit a radar-transmit signal and receive a radar-receive signal using the at least one antenna; at least one processor; and a computer-readable store media comprising instructions, responsive to execution by the processor, for directing the computing device to perform any one of the methods recited in examples 1 to 14.
Example 16: A computing system comprising a first computing device and a second computing device connected to a communication network to enable: the first computing device or the second computing device to perform any one of the methods recited in examples 1 to 14; and an exchange of information between the first computing device and the second computing device, the information including at least one of the following: one or more detected radar characteristics; one or more stored radar characteristics; topological information; temporal information; gestural information; contextual information; or one or more audio signals.

1. A method comprising:
transmitting a radar-transmit signal from a radar system associated with a computing device;
receiving, at the radar system or another radar system associated with the computing device, a radar-receive signal;
determining, from the radar-receive signal, a radar characteristic of an object from which the radar-receive signal is reflected;
determining, based on the radar characteristic of the object, that the object is an unregistered person, the unregistered person not a registered user associated with the computing device;
assigning, to the unregistered person, an unregistered user identification;
associating the radar characteristic of the object to the unregistered user identification; and
storing the unregistered user identification and the associated radar characteristic, the associated radar characteristic usable to determine, at a future time, a presence of the unregistered person by correlating a future-received radar-receive signal having a similar or identical radar characteristic with the associated radar characteristic of the unregistered person.

2. The method as recited by claim 1, the method further comprising:
transmitting a second radar-transmit signal from the radar system or the other radar system associated with the computing device;
receiving, at the radar system or the other radar system, a second radar-receive signal associated with a second radar characteristic, the second radar characteristic similar or identical to the associated radar characteristic of the unregistered person; and
comparing the second radar characteristic to the radar characteristic associated with the stored unregistered user identification, the comparing effective to determine the presence of the unregistered person.

3. The method as recited by claim 1, the method further comprising:
transmitting a third radar-transmit signal from the radar system or the other radar system associated with the computing device;
receiving, at the radar system or the other radar system, a third radar-receive signal associated with a third radar characteristic; and
comparing the third radar characteristic to one or more stored radar characteristics of the registered user, the comparing effective to correlate the third radar characteristic to a first stored radar characteristic of the registered user, the correlation indicating a presence of the registered user.

4. The method as recited by claim 1, wherein the presence of the unregistered person is determined without using personally identifiable information, the personally identifiable information including at least one of the following:
face-recognition information;
biometric information;
content of private conversations;
legally identifiable information;
identification of an electronic tag; or
identification of a personal electronic device.

5. The method as recited by claim 1, wherein the radar characteristic includes topological information of the object, the topological information including at least one of the following:
radar cross-sectional data;
geometric information;
texture information;
a surface smoothness; or
a structural configuration.

6. The method as recited by claim 1, wherein the radar characteristic includes temporal information of the object, the temporal information associated with one or more movements of the object over time.

7. The method as recited by claim 1, wherein the radar characteristic includes gestural information associated with a way in which the object performs one or more gestures to control or alter a display, function, or capability of the computing device or associated with the computing device.

8. The method as recited by claim 1, further comprising associating, with the unregistered user identification, contextual information including at least one of the following:
a status of operations being performed by the computing device at a current time, past time, or scheduled time;
a location of the computing device; or
a recorded habit or preference of the registered user or the unregistered person.

9. The method as recited by claim 8, wherein the contextual information includes the recorded habit or preference of the unregistered person, the recorded habit or preference including a time of day or day of a week, and further comprising determining, based on the stored associated radar characteristic and the time of the day or the day of the week, the presence, at the future time, of the unregistered person.

10. The method as recited by claim 1, the method further comprising:
responsive to determining that the object is the unregistered person, providing gesture training to teach the unregistered person to perform a gesture to control or alter a display, function, or capability of the computing device or associated with the computing device;
storing, for the unregistered person, a training history for the gesture as performed by the unregistered person during gesture training, the stored training history associated with the unregistered user identification; and
responsive to determining the presence of the unregistered person at the future time, either:
resuming gesture training based on the stored training history; or
recognizing, based on the stored training history, a future-received gesture as the gesture to control or alter the display, function, or capability.

11. The method as recited by claim 1, wherein determining the presence of the unregistered person at the future time is further based on a machine-learned model that utilizes the associated radar characteristic of the unregistered person.

12. The method as recited by claim 1, the method further comprising:
detecting, at the computing device, a first gesture performed by the unregistered person, the first gesture associated with an operation to be performed by the computing device over a duration of time;
implementing the operation;
detecting, at the computing device, a second gesture performed by another user to change the operation during the duration of time; and
refraining from changing the operation based on the second gesture being performed by the other user who is not the unregistered person.

13. The method as recited by claim 1, the method further comprising:
receiving, at the computing device, an audio signal of the object;
determining an audio characteristic of the audio signal without determining one or more words associated with the audio signal; and
responsive to determining that the object is the unregistered person:
associating the audio characteristic with the unregistered user identification; and
storing the associated audio characteristic to enable determination of the presence of the unregistered person at the future time by correlating a future-received audio signal having a similar or identical audio characteristic with the associated audio characteristic.

14. A computing device comprising:
at least one antenna;
a radar;
at least one processor; and
a computer-readable storage media comprising instructions that, responsive to execution by the processor, are configured to direct the computing device to perform operations including:
transmitting, using the radar system, a radar-transmit signal;
receiving, a radar-receive signal using the at least one antenna;
determining, from the radar-receive signal, a radar characteristic of an object from which the radar-receive signal is reflected;
determining, based on the radar characteristic of the object, that the object is an unregistered person, the unregistered person not a registered user associated with the computing device;
assigning, to the unregistered person, an unregistered user identification;
associating the radar characteristic of the object to the unregistered user identification; and
storing the unregistered user identification and the associated radar characteristic, the associated radar characteristic usable to determine, at a future time, a presence of the unregistered person by correlating a future-received radar-receive signal having a similar or identical radar characteristic with the associated radar characteristic of the unregistered person.

15. (canceled)

16. The computing device of claim 14, further comprising:
transmitting a second radar-transmit signal;
receiving a second radar-receive signal associated with a second radar characteristic, the second radar characteristic similar or identical to the associated radar characteristic of the unregistered person; and
comparing the second radar characteristic to the radar characteristic associated with the stored unregistered user identification, the comparing effective to determine the presence of the unregistered person.

17. The computing device of claim 14, further comprising:
transmitting a third radar-transmit signal;
receiving a third radar-receive signal associated with a third radar characteristic; and
comparing the third radar characteristic to one or more stored radar characteristics of the registered user, the comparing effective to correlate the third radar characteristic to a first stored radar characteristic of the registered user, the correlation indicating a presence of the registered user.

18. The computing device of claim 14, wherein the presence of the unregistered person is determined without using personally identifiable information, the personally identifiable information including at least one of the following:
face-recognition information;
biometric information;
content of private conversations;
legally identifiable information;
identification of an electronic tag; or
identification of a personal electronic device.

19. The computing device of claim 14, wherein the radar characteristic includes:
topological information of the object, the topological information including at least one of the following:
radar cross-sectional data;
geometric information;
texture information;
a surface smoothness; or
a structural configuration;
temporal information of the object, the temporal information associated with one or more movements of the object over time; and
gestural information associated with a way in which the object performs one or more gestures to control or alter a display, function, or capability of the computing device or associated with the computing device.

20. The computing device of claim 14, further comprising:
responsive to determining that the object is the unregistered person, providing gesture training to teach the unregistered person to perform a gesture to control or alter a display, function, or capability of the computing device or associated with the computing device;
storing, for the unregistered person, a training history for the gesture as performed by the unregistered person during gesture training, the stored training history associated with the unregistered user identification; and
responsive to determining the presence of the unregistered person at the future time, either:
resuming gesture training based on the stored training history; or
recognizing, based on the stored training history, a future-received gesture as the gesture to control or alter the display, function, or capability.

21. The computing device of claim 14, wherein determining the presence of the unregistered person at the future time is further based on a machine-learned model that utilizes the associated radar characteristic of the unregistered person.
